(19) United States
(12) Patent Application Publication
(10) Pub. No.: US 2012/0244306 A1
(43) Pub. Date: Sep. 27, 2012

(54) LABEL

(75) Inventors: Tomoya Hosoda, Tsukuba-shi (JP); Satoshi Okamoto, Tsukuba-shi (JP)

(73) Assignee: SUMITOMO CHEMICAL COMPANY, LIMITED

(21) Appl. No.: 13/514,419

(22) PCT Filed: Dec. 6, 2010
(86) PCT No.: PCT/JP2010/071801

§ 371 Date: Jun. 7, 2012

(30) Foreign Application Priority Data
Dec. 10, 2009 (JP) 2009-280037

(51) Int. Cl. C08G 63/60; B32B 7/12; B32B 33/00; C08L 67/03

(52) U.S. Cl. 428/41.7; 528/182; 524/605; 428/343

(57) ABSTRACT

A heat-resistant label containing a liquid crystalline polyester base material, wherein the liquid crystalline polyester in this liquid crystalline polyester base material contains a structural unit represented by the following formula (1), a structural unit represented by the following formula (2) and a structural unit represented by the following formula (3), and wherein the amount of structural units containing a 2,6 naphthalenediyl group is at least 40 mol % based on the total amount of all the structural units:
(1) —O—Ar¹—CO—
(2) —CO—Ar²—CO— and
(3) —O—Ar³—O—
   (wherein, Ar¹ represents a 2,6-naphthalenediyl group, a 1,4-phenylene group, or a 4,4′-biphenylylene group; each of Ar² and Ar³ independently represents a 2,6-naphthalenediyl group, a 1,4-phenylene group, a 1-3-phenylene group, or a 4,4′-biphenylylene group; and hydrogen atoms which are in the group represented by Ar¹, Ar² or Ar³ may be each independently substituted with a halogen atom, an alkyl group having 1 to 10 carbon atoms, or an aryl group having 6 to 20 atoms).

### TECHNICAL FIELD

The present invention relates to a label that exhibits excellent heat resistance. Priority is claimed on Japanese Patent Application No. 2009-280037, filed Dec. 10, 2009, the content of which is incorporated herein by reference.

### BACKGROUND ART

In industrial fields such as machinery, electrical and electronic componentry, and foodstuffs, labels on which a barcode has been printed are often stuck to products or the packaging materials thereof, mainly for the purpose of process control during production.

Then, depending on the product, during the production process, the product may be placed under high-temperature conditions and subjected to a predetermined treatment with the label stuck to the product or the packaging material. In this case, because heat energy is also applied to the label during the treatment of the product, the material that constitutes the label also requires a high level of heat resistance.

As an example of this type of highly heat resistant label, Patent Document 1 proposes a technique in which a base material made of a liquid crystalline polyester, namely a liquid crystalline polyester base material, is formed by an extrusion molding method, and this liquid crystalline polyester base material is then used to produce a label.

### DOCUMENTS OF RELATED ART

### Patent Documents

[Patent Document 1] JP-2004-13054-A (paragraphs [0062] and [0095])

### DISCLOSURE OF INVENTION

### Problems to be Solved by the Invention

However, in the label proposed in Patent Document 1, although the label exhibits satisfactory heat resistance relative to high-temperature treatment of the product, because the light resistance and water vapor barrier properties are not good, a problem exists in that the label may partially peel off if used over a long period of time. With a label that has undergone this type of peeling, there is a concern that the information incorporated in the barcode may be unable to be read accurately. Accordingly, with respect to this matter, there is still room for improvement.

In light of these circumstances, an object of the present invention is to provide a label which, even if used over a long period of time, can prevent the occurrence of peeling caused by insufficient light resistance or unsatisfactory water vapor barrier properties, thus avoiding misreading of information.

### Means to Solve the Problems

The inventors of the present invention discovered that by using a liquid crystalline polyester base material having a specific structure, the light resistance and the water vapor barrier properties could be improved, and they were therefore able to complete the present invention.

In other words, a first aspect of the present invention is a label containing a liquid crystalline polyester base material, wherein the liquid crystalline polyester in the liquid crystalline polyester base material contains a structural unit represented by the following formula (1), a structural unit represented by the following formula (2) and a structural unit represented by the following formula (3), and wherein the amount of structural units containing a 2,6 naphthalenediyl group is at least 40 mol % but no more than 95 mol % based on the total amount of all the structural units:
(1) —O—Ar¹—O—
(2) —CO—Ar²1'O— and
(3) —O—Ar³—O—
(wherein, Ar¹ represents a 2,6-naphthalenediyl group, a 1,4-phenylene group, or a 4,4′-biphenylylene group; each of Ar² and Ar³ independently represents a 2,6-naphthalenediyl group, a 1,4-phenylene group, a 1-3-phenylene group, or a 4,4′-biphenylylene group; and hydrogen atoms which are in the group represented by Ar¹, Ar² or Ar³ may be each independently substituted with a halogen atom, an alkyl group having 1 to 10 carbon atoms, or an aryl group having 6 to 20 atoms).

A second aspect of the present invention is a label in which, in addition to the composition of the first aspect described above, the liquid crystalline polyester has aflow beginning temperature flow beginning temperature that is at least 280° C.

A third aspect of the present invention is a label in which, in addition to the composition of the first or second aspect described above, the liquid crystalline polyester base material has a water vapor permeation rate that is no more than 0.1 g/m²·24 h when measured at a temperature of 40° C. and at a relative humidity of 90%.

A fourth aspect of the present invention is a label containing a liquid crystalline polyester base material, wherein the liquid crystalline polyester base material has a water vapor permeation rate that is no more than 0.005 g/m²1·24 h when measured at a temperature of 40° C. and at a relative humidity of 90%.

A fifth aspect of the present invention is a label containing a liquid crystalline polyester base material, wherein the liquid crystalline polyester in the liquid crystalline polyester base material has a water vapor permeation rate that is no more than 0.005 g/m²·24 h when measured at a film thickness of 50 μm, at a temperature of 40° C., and at a relative humidity of 90%.

A sixth aspect of the present invention is a label in which, in addition to the composition of any one of the first to fifth aspects described above, the liquid crystalline polyester base material contains an ultraviolet absorption agent and/or an ultraviolet scattering agent.

A seventh aspect of the present invention is a label in which, in addition to the composition of any one of the first to sixth aspects described above, an adhesive layer is laminated on the rear surface of the liquid crystalline polyester base material.

An eighth aspect of the present invention is a label in which, in addition to the composition of the seventh aspect described above, a protective film is releasably laminated on the rear surface of the adhesive layer.

Moreover, a ninth aspect of the present invention is a label in which, in addition to the composition of any one of the first to eighth aspects described above, a symbol is provided on a surface of the liquid crystalline polyester base material.

### EFFECTS OF THE INVENTION

According to the present invention, because the liquid crystalline polyester base material is formed from a specific liquid crystalline polyester that exhibits excellent light resistance and water vapor barrier properties, the occurrence of peeling caused by insufficient light resistance or unsatisfactory water vapor barrier properties can be prevented even if the label is used over a long period of time. Accordingly, in those cases where information is incorporated in the label, misreading of that information can be avoided.

### BRIEF DESCRIPTION OF THE DRAWINGS

FIG. 1A is a plan view of a label according to an embodiment 1 of the present invention.

FIG. 1B is an expanded cross-sectional view along the line B-B in FIG. 1A.

FIG. 2A is a diagram illustrating a label sticking process during process control of a product.

FIG. 2B is a diagram illustrating a high-temperature treatment process during process control of a product.

FIG. 3A is a plan view of a label according to an embodiment 2 of the present invention.

FIG. 3B is an expanded cross-sectional view along the line B-B in FIG. 3A.

### MODES FOR CARRYING OUT THE INVENTION

### Embodiment 1 of the Invention

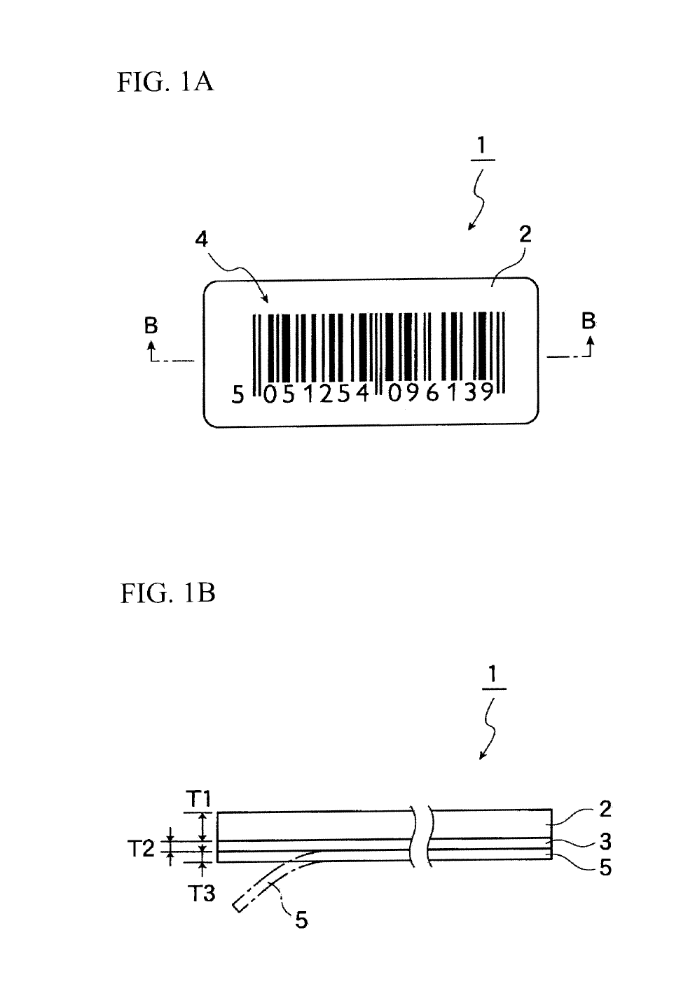

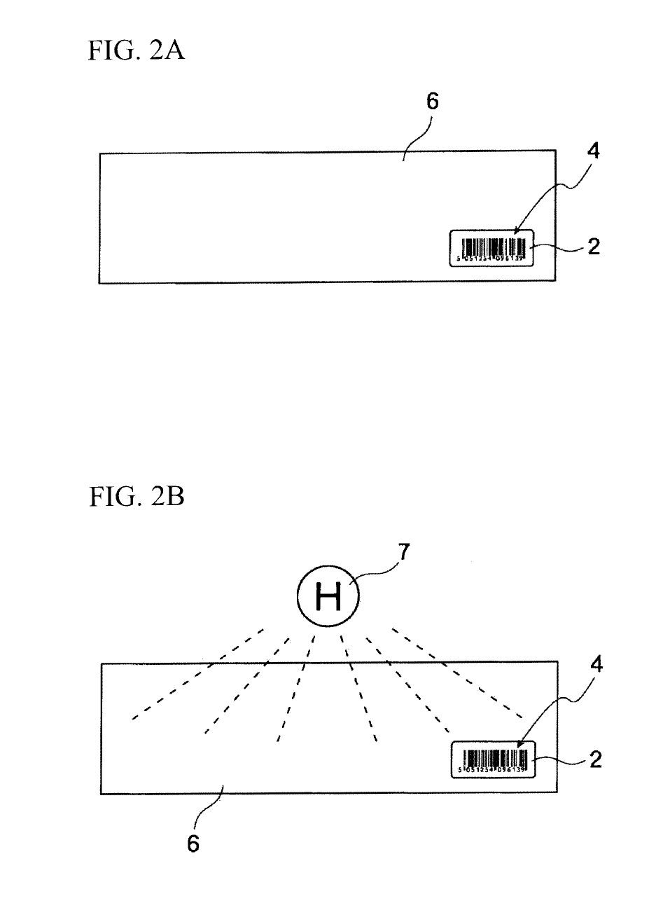

An embodiment 1 of the present invention is illustrated in FIG. 1A, FIG. 1B, FIG. 2A and FIG. 2B.

First is a description of the structure of a label 1 according to the embodiment 1.

As illustrated in FIG. 1B, this label 1 is equipped with a 3-layer structure composed of a liquid crystalline polyester base material 2, an adhesive layer 3 and a protective film 5, and the overall structure is flexible.

In other words, as illustrated in FIG. 1 B, the label 1 has a sheet-like liquid crystalline polyester base material 2 of a predetermined thickness T1 (for example, T1=10 to 300 μm). As illustrated in FIG. 1A, a barcode 4 for process control is printed on a surface (the upper surface in FIG. 1B) of the liquid crystalline polyester base material 2. The adhesive layer 3 of a predetermined thickness T2 (for example, T2=5 to 100 μm) is laminated on the rear surface (the lower surface in FIG. 1B) of the liquid crystalline polyester base material 2 across the entire rear surface. Further, the protective film 5 of a predetermined thickness T3 (for example, T3=20 to 150 μm) is releasably laminated on the rear surface (the lower surface in FIG. 1B) of the adhesive layer 3, across the entire rear surface, so as to be releasable from the adhesive layer 3 as shown by the dotted line in FIG. 1B. A release paper or the like can be used as this protective film 5.

The liquid crystalline polyester in this liquid crystalline polyester base material exhibits optical anisotropy when melted, and contains a structural unit represented by the following formula (1), a structural unit represented by the following formula (2), and a structural unit represented by the following formula (3). Further, in the liquid crystalline polyester, the amount of structural units containing a 2,6 naphthalenediyl group is at least 40 mol % but no more than 95 mol % based on the total amount of all structural units (the value obtained by determining the relative amount of substance (mols) of each structural unit by dividing the mass of each structural unit contained in the liquid crystalline polyester by the formula weight of the structural unit, and then totaling the relative amount of substance of all the structural units). Moreover, the liquid crystalline polyester preferably has a flow beginning temperature that is at least 280° C., and a maximum value for the melt tension, measured at a temperature higher than the flow beginning temperature, that is at least 0.0098 N.
(1) —O—Ar¹—CO—
(2) —CO—Ar²—O— and
(3) —O—Ar³—O—
(wherein, Ar¹ represents a 2,6-naphthalenediyl group, a 1,4-phenylene group, or a 4,4′-biphenylylene group; each of Ar² and Ar³ independently represents a 2,6-naphthalenediyl group, a 1,4-phenylene group, a 1-3-phenylene group, or a 4,4′-biphenylylene group; and hydrogen atoms which are in the group represented by Ar¹, Ar² or Ar³, may be each independently substituted with a halogen atom, an alkyl group having 1 to 10 carbon atoms, or an aryl group having 6 to 20 atoms).

Here, a “liquid crystalline polyester” means a polyester that exhibits optical anisotropy when melted at a temperature of no more than 450° C. This type of liquid crystalline polyester can be obtained by selecting, in the production stage, monomers containing a 2,6-naphthalenediyl group and other monomers containing an aromatic ring, and then polymerizing the monomers so that, in the resulting liquid crystalline polyester, the amount of structural units containing a 2,6 naphthalenediyl group is at least 40 mol %.

In this manner, because the label 1 containing the liquid crystalline polyester base material 2 includes the liquid crystalline polyester containing a structural unit represented by the above formula (1), a structural unit represented by the above formula (2) and a structural unit represented by the above formula (3), wherein the amount of structural units containing a 2,6 naphthalenediyl group is at least 40 mol % based on the total amount of all the structural units, the light resistance and the water vapor barrier properties can be enhanced. As a result, the occurrence of peeling caused by insufficient light resistance or unsatisfactory water vapor barrier properties can be prevented even if the label 1 is used over a long period of time. Accordingly, the information incorporated in the barcode 4 on the label 1 can always be read accurately.

For the liquid crystalline polyester used in the present invention, a liquid crystalline polyester in which the amount of structural units containing a 2,6 naphthalenediyl group is at least 50 mol % based on the total amount of all the structural units is preferred, a liquid crystalline polyester in which the amount of structural units containing a 2,6 naphthalenediyl group is at least 65 mol % is more preferred, and a liquid crystalline polyester in which the amount of structural units containing a 2,6 naphthalenediyl group is at least 70 mol % is still more preferred. In this manner, a liquid crystalline polyester containing a large amount of structural units containing a 2,6 naphthalenediyl group is able to further improve the light resistance and water vapor barrier properties of the label. From the viewpoint of these types of properties of the liquid crystalline polyester, there are no particular limitations on the upper limit for the amount of structural units containing a 2,6 naphthalenediyl group, but if, for example, the productivity of the liquid crystalline polyester is also considered, then the amount is preferably no more than 95 mol %, more preferably no more than 90 mol %, and still more preferably no more than 85 mol %.

Based on the total amount of all the structural units, the total amount of structural units derived from an aromatic hydroxycarboxylic acid represented by the above formula (1) is preferably from 30 to 80 mol %, the total amount of structural units derived from an aromatic dicarboxylic acid represented by the above formula (2) is preferably from 10 to 35 mol %, and the amount of structural units derived from an aromatic diol represented by the above formula (3) is preferably from 10 to 35 mol %.

In the liquid crystalline polyester used in the present invention, the structural unit represented by the formula (1), the structural unit represented by the formula (2) and the structural unit represented by the formula (3) may each independently include two or more types of structural units. Further, the liquid crystalline polyester used in the present invention may also contain a structural unit other than the structural unit represented by the formula (1), the structural unit represented by the formula (2) and the structural unit represented by the formula (3), but the amount of this other structural unit is typically no more than 10 mol %, and preferably no more than 5 mol %, based on the total amount of all the structural units.

Furthermore, the liquid crystalline polyester used in the present invention is preferably a totally aromatic liquid crystalline polyester. Here, a “totally aromatic liquid crystalline polyester” is a liquid crystalline polyester produced using only aromatic compounds as the raw material monomers. Totally aromatic liquid crystalline polyesters exhibit excellent heat resistance, and can therefore be used favorably as label materials.

Provided the respective amounts of the structural units derived from an aromatic hydroxycarboxylic acid, the structural units derived from an aromatic dicarboxylic acid, and the structural units derived from an aromatic diol satisfy the aforementioned ranges based on the total amount of all the structural units, the liquid crystalline polyester not only exhibits a high degree of liquid crystallinity, but also exhibits excellent melt workability, which is desirable.

The amount of the structural units derived from an aromatic hydroxycarboxylic acid, based on the total amount of all the structural units, is more preferably from 40 to 70 mol %, and an amount from 45 to 65 mol % is particularly desirable. On the other hand, the amounts of the structural units derived from an aromatic dicarboxylic acid and the structural units derived from an aromatic diol, based on the total amount of all the structural units, are each more preferably from 15 to 30 mol %, and an amount from 17.5 to 27.5 mol % is particularly desirable.

Examples of the monomer that forms the structural unit represented by the above formula (1) include 2-hydroxy-6-naphthoic acid, p-hydroxybenzoic acid or 4-(4-hydroxyphenyl)benzoic acid. Moreover, monomers in which a hydrogen atom on the benzene ring or naphthalene ring of these compounds has been substituted with a halogen atom, an alkyl group having 1 to 10 carbon atoms, or an aryl group can also be used. Here, 2-hydroxy-6-naphthoic acid is presented as an example of a monomer that forms a structural unit containing a 2,6 naphthalenediyl group of the present invention. Moreover, a hydrogen atom on the naphthalene ring of the 2-hydroxy-6-naphthoic acid may be substituted with a halogen atom, an alkyl group having 1 to 10 carbon atoms, or an aryl group. The 2-hydroxy-6-naphthoic acid may also be used in the form of an ester-forming derivative described below.

Examples of the monomer that forms the structural unit represented by the above formula (2) include 2,6-naphthalenedicarboxylic acid, terephthalic acid, isophthalic acid or biphenyl-4,4′-dicarboxylic acid. Moreover, monomers in which a hydrogen atom on the benzene ring or naphthalene ring of these compounds has been substituted with a halogen atom, an alkyl group having 1 to 10 carbon atoms, or an aryl group can also be used. Here, 2,6-naphthalenedicarboxylic acid is presented as an example of a monomer that forms a structural unit containing a 2,6 naphthalenediyl group of the present invention. Moreover, a hydrogen atom on the naphthalene ring of the 2,6-naphthalenedicarboxylic acid may be substituted with a halogen atom, an alkyl group having 1 to 10 carbon atoms, or an aryl group. The 2,6-naphthalenedicarboxylic acid may also be used in the form of an ester-forming derivative described below.

Examples of the monomer that forms the structural unit represented by the above formula (3) include 2,6-naphthalenediol, hydroquinone, resorcin or 4,4′-dihydroxybiphenyl. Moreover, monomers in which a hydrogen atom on the benzene ring or naphthalene ring of these compounds has been substituted with a halogen atom, an alkyl group having 1 to 10 carbon atoms, or an aryl group can also be used. Here, 2,6-naphthalenediol is presented as an example of a monomer that forms a structural unit containing a 2,6 naphthalenediyl group of the present invention. Moreover, a hydrogen atom on the naphthalene ring of the 2,6-naphthalenediol may be substituted with a halogen atom, an alkyl group having 1 to 10 carbon atoms, or an aryl group. The 2,6-naphthalenediol may also be used in the form of an ester-forming derivative described below.

As described above, the structural units represented by the above formulas (1), (2) and (3) may each include an aforementioned substituent (a halogen atom, an alkyl group having 1 to 10 carbon atoms, or an aryl group) on the aromatic ring (the benzene ring or the naphthalene ring). Examples of these substituents, in terms of the halogen atom, include a fluorine atom, chlorine atom, bromine atom and iodine atom. Further, examples of the alkyl group having 1 to 10 carbon atoms include alkyl groups typified by a methyl group, ethyl group, propyl group, butyl group, hexyl group, octyl group and decyl group, and these groups may be linear or branched groups, or alicyclic groups. Examples of the aryl group include aryl groups having 6 to 20 carbon atoms typified by a phenyl group and a naphthyl group.

In order to facilitate polymerization during the process for producing the liquid crystalline polyester, an ester-forming derivative is preferably used as the monomer that forms the structural unit represented by the formula (1), (2) or (3). This “ester-forming derivative” describes a monomer having a type of group that promotes an ester formation reaction. Specific examples include highly reactive derivatives such as ester-forming derivatives in which a carboxyl group within the monomer molecule has been replaced with a haloformyl group or an acyloxycarbonyl group, and ester-forming derivatives in which a hydroxyl group within the monomer molecule has been replaced with an acyloxyl group.

From the viewpoints of improving the heat resistance and the melt tension, the liquid crystalline polyester disclosed in JP-2005-272810-A is a preferred combination of monomers for the liquid crystalline polyester used in the present invention. Specifically, this is a liquid crystalline polyester in which the amount of a structural unit (I) derived from 2-hydroxy-6-naphthoic acid is from 40 to 74.8 mol %, the amount of a structural unit (II) derived from hydroquinone is from 12.5 to 30 mol %, the amount of a structural unit (III) derived from 2,6-naphthalenedicarboxylic acid is from 12.5 to 30 mol %, and the amount of a structural unit (IV) derived from terephthalic acid is from 0.2 to 15 mol %, wherein the molar ratio between the structural units (III) and (IV) satisfies the relationship: (III)/{(III)+(IV)}≧0.5.

More preferable liquid crystalline polyesters include those in which, based on the total amount of all the structural units, the amount of the structural unit (I) is from 40 to 64.5 mol %, the amount of the structural unit (II) is from 17.5 to 30 mol %, the amount of the structural unit (III) is from 17.5 to 30 mol %, and the amount of the structural unit (IV) is from 0.5 to 12 mol %, and wherein the molar ratio between the structural units (III) and (IV) satisfies: (III)/{(III)+(IV)}≧0.6.

Still more preferable liquid crystalline polyesters include those in which, based on the total amount of all the structural units, the amount of the structural unit (I) is from 50 to 58 mol %, the amount of the structural unit (II) is from 20 to 25 mol %, the amount of the structural unit (III) is from 20 to 25 mol %, and the amount of the structural unit (IV) is from 2 to 10 mol %, and wherein the molar ratio between the structural units (III) and (IV) satisfies: (III)/{(III)+(IV)}≧0.6.

Further, conventional methods can be employed as the production method for the liquid crystalline polyester, and production is preferably conducted using, as the aforementioned ester-forming derivative, a derivative in which a hydroxyl group in the monomer molecule has been converted to an acyloxyl group using a lower carboxylic acid. Acylation can usually be achieved by reacting a monomer containing a hydroxyl group with acetic anhydride. An ester-forming derivative prepared by this type of acylation can be polymerized by an acetic acid-eliminating polycondensation, and readily produces a polyester.

Conventional methods (such as the method disclosed in JP-2002-146003-A) can be applied as the liquid crystalline polyester production method. In other words, the monomers corresponding with the structural unit represented by the formula (1), the structural unit represented by the formula (2) and the structural unit represented by the formula (3) are selected so that the amount of monomers that correspond with structural units containing a 2,6-naphthalenediyl group is at least 40 mol % but no more than 95 mol % based on the total amount of all the structural units, the monomers are converted to ester-forming derivatives where necessary, and a melt polycondensation is then performed to obtain a comparatively low molecular weight aromatic liquid crystalline polyester (hereinafter abbreviated as the “prepolymer”). Subsequently, this prepolymer is converted to a powder, and a solid phase polymerization is conduced by heating. By using this type of solid phase polymerization, the polymerization proceeds more readily, enabling the molecular weight to be increased.

In order to convert the prepolymer obtained in the melt polycondensation to a powder, the prepolymer can, for example, be solidified by cooling, and then ground. The particle size of the powder is preferably an average of at least 0.05 mm but no more than approximately 3 mm. A particle size of at least 0.05 mm but no more than approximately 1.5 mm is more preferable, as it promotes an increase in the polymerization degree of the aromatic liquid crystalline polyester, and if the particle size is at least 0.1 mm but no more than approximately 1 mm, then an increase in the polymerization degree of the aromatic liquid crystalline polyester is promoted without causing sintering between particles of the powder, which is particularly desirable.

The heating in the solid phase polymerization is typically conducted while the temperature is increased, and for example, the temperature is increased from room temperature to a temperature that is at least 20° C. lower than the flow beginning temperature of the prepolymer. Although there are no particular limitations on the time over which the temperature is increased, from the viewpoint of shortening the reaction time, a time of no more than 1 hour is preferable.

In the production of the liquid crystalline polyester, the heating in the solid phase polymerization is preferably performed by increasing the temperature from a temperature that is at least 20° C. lower than the flow beginning temperature of the prepolymer to a temperature of at least 280° C. This temperature increase is preferably performed at a rate of temperature increase of no more than 0.3° C./minute. This rate of temperature increase is preferably from 0.1 to 0.15° C./minute. Provided this rate of temperature increase is no more than 0.3° C./minute, sintering between particles of the powder is unlikely to occur, which facilitates the production of a liquid crystalline polyester having a high polymerization degree, and is consequently preferred.

In order to increase the polymerization degree of the liquid crystalline polyester, the heating in the solid phase polymerization will vary depending on the type of monomer used for the aromatic diol or aromatic dicarboxylic acid component of the obtained liquid crystalline resin, but the reaction is typically performed at a temperature of at least 280° C., and preferably at a temperature within a range from 280 to 400° C., for a period of at least 30 minutes. In particular, from the viewpoint of the thermal stability of the liquid crystalline resin, the reaction is preferably performed at a reaction temperature of 280 to 350° C. for 30 minutes to 30 hours, and is more preferably performed at a reaction temperature of 285 to 340° C. for 30 minutes to 20 hours.

In the present invention, the “flow beginning temperature of the liquid crystalline polyester” means the value obtained by measuring a pellet obtained by subjecting the liquid crystalline polyester (powder or pellets) obtained in the production method described above to melt kneading using an extruder. A flow beginning temperature of at least 280° C. for this pellet is essential from the viewpoint of improving the heat resistance, and in particular the heat resistance required for withstanding a solder reflow process performed as a high-density packaging technique. In particular, if the flow beginning temperature of the liquid crystalline polyester is at least 290° C. but no more than 380° C., then the heat resistance is high and degradation of the polymer during molding can be suppressed, and a flow beginning temperature of at least 295° C. but no more than 350° C. is particularly desirable.

Here, the “flow beginning temperature” is measured using a capillary rheometer equipped with a die having an internal diameter of 1 mm and a length of 10 mm, and is the temperature at which the melt viscosity reaches 4,800 Pa·s (48,000 poise) when the liquid crystalline polyester is extruded from the nozzle under a loading of 9.8 MPa (100 kgf/cm²) and at a rate of temperature increase of 4° C./minute (for example, see “Liquid Crystal Polymers—Synthesis·Molding·Applications”, edited by Naoyuki Koide, pages 95 to 105, published by CMC Publishing Co., Ltd., June 5, 1987).

The liquid crystalline polyester obtained in this manner and having the predetermined structural unit composition described above exhibits excellent water vapor barrier properties, and the water vapor permeation rate measured at a film thickness of 50 μm, at a temperature of 40° C., and at a relative humidity of 90% is preferably no more than 0.005 g/m²·24 h.

Next is a description of a specific method of melt kneading the liquid crystalline polyester (powder or pellets) obtained in the above production method using an extruder.

For example, using a single screw or multi-screw extruder, and preferably a twin screw extruder, a Banbury kneader, or a roll-type kneader or the like, melt kneading is performed within a temperature range from a temperature 10° C. lower than the flow beginning temperature of the simple resin substance (powder or pellets) obtained in the above production method for a liquid crystalline polyester to a temperature 100° C. higher than the flow beginning temperature, thus yielding pellets. From the viewpoint of preventing thermal degradation of the liquid crystalline polyester, a range from a temperature 10° C. lower than the flow beginning temperature to a temperature 70° C. higher than the flow beginning temperature is preferable, and a range from a temperature 10° C. lower than the flow beginning temperature to a temperature 50° C. higher than the flow beginning temperature is more preferable.

Further, the liquid crystalline polyester used in the present invention can be converted to a liquid crystalline polyester resin composition by adding a filler or the like to the polyester.

Examples of the filler include glass fiber such as milled glass fiber and chopped glass fiber; inorganic fillers such as glass beads, hollow glass spheres, glass powder, mica, talc, clay, silica, alumina, potassium titanate, wollastonite, calcium carbonate (heavy, light or colloidal or the like), magnesium carbonate, basic magnesium carbonate, sulfate of soda, calcium sulfate, barium sulfate, calcium sulfite, aluminum hydroxide, magnesium hydroxide, calcium hydroxide, calcium silicate, quartz sand, silica stone, quartz, titanium oxide, zinc oxide, iron oxide, graphite, molybdenum, asbestos, silica-alumina fiber, alumina fiber, plaster fiber, carbon fiber, carbon black, white carbon, diatomaceous earth, bentonite, sericite, shirasu (volcanic ash) and black lead; metal whiskers or non-metal whiskers such as potassium titanate whiskers, alumina whiskers, aluminum borate whiskers, silicon carbide whiskers and silicon nitride whiskers; and mixtures of two or more of these fillers. Among these, glass fiber, glass powder, mica, talc and carbon fiber and the like are preferable.

Furthermore, the filler may have been subjected to a surface treatment with a surface treatment agent. Examples of this surface treatment agent include reactive coupling agents such as silane coupling agents, titanate coupling agents and borane coupling agents, as well as lubricants and the like such as higher fatty acids, higher fatty acid esters, metal salts of higher fatty acids, and fluorocarbon-based surfactants.

The amount used of these fillers is typically within a range from 0.1 to 400 parts by mass, preferably from 10 to 400 parts by mass, and more preferably from 10 to 250 parts by mass, based on 100 parts by mass of the aromatic liquid crystalline polyester.

Further, besides the filler described above, the liquid crystalline polyester resin composition may also include thermoplastic resins other than the liquid crystalline polyester and additives and the like.

Examples of the thermoplastic resins include polycarbonate resins, polyamide resins, polysulfone resins, polyphenylene sulfide resins, polyphenylene ether resins, polyether ketone resins and polyether imide resins.

Furthermore, examples of the additives include ultraviolet absorption agents (such as benzotriazole-based ultraviolet absorption agents), ultraviolet scattering agents (such as titanium oxide and zinc oxide), photostabilizers (such as hindered amine-based photostabilizers), antioxidants, stabilizers, mold release improvers (such as fluororesins and metal soaps), nucleating agents, plasticizers, slip additives, coloring agents, anti-coloring agents, anti-static agents, lubricants and flame retardants. By including an ultraviolet absorption agent or an ultraviolet scattering agent, ultraviolet radiation, which is harmful to the liquid crystalline polyester, can be absorbed or reflected and scattered, enabling the light resistance of the label 1 to be improved even further.

The liquid crystalline polyester resin composition can be produced, for example, by mixing the liquid crystalline polyester obtained in the manner described above, the type of filler described above, and any thermoplastic resins or additives and the like which are used as required. For the mixing performed at this time, a mortar, a Henschel mixer, a ball mill or a ribbon blender or the like may be used, or a melt kneader such as single screw extruder, twin screw extruder, Banbury mixer, roll, Brabender or kneader may be used, wherein the mixing is preferably conducted under the melt kneading conditions described above.

In the liquid crystalline polyester used in the present invention, the maximum value for the melt tension, measured at a temperature higher than the flow beginning temperature of the pellets obtained by performing melt kneading of the liquid crystalline polyester (powder or pellets) obtained in the above production method, is preferably at least 0.0098 N (more preferably at least 0.015 N, and still more preferably at least 0.020 N). Moreover, by using a liquid crystalline polyester for which the maximum value for the melt tension measured at a temperature that is 25° C. higher than the flow beginning temperature is at least 0.0098 N, the liquid crystalline polyester base material 2 can be produced in a stable manner.

This “melt tension” means the tensile force at fracture (units: N) when a melt viscosity measurement tester (flow properties tester) is filled with the pellets obtained by performing melt kneading of the liquid crystalline polyester (powder or pellets) obtained in the above production method, and the sample is pulled out into a thread-like form using a cylinder barrel diameter of 1 mm and a piston extrusion rate of 5 mm/minute, while the rate is automatically increased using a variable speed winder.

In a production method for the liquid crystalline polyester base material 2 used in the present invention, the liquid crystalline polyester can also be used, for example, in the form of a film or sheet obtained using a T-die method in which the melted resin is extruded from a T-die and rolled, or an inflation film formation method in which the melted resin is extruded in a circular cylindrical shape from an extruder fitted with an annular die, and is then cooled and rolled, a film or sheet obtained using a hot press method or a solvent casting method, or a film or sheet obtained by subjecting a sheet obtained using an injection molding method or an extrusion method to additional uniaxial stretching or biaxial stretching. In the case of injection molding or extrusion molding, a film or sheet can also be obtained without performing an initial mixing process, by dry blending the powders or pellets of the components at the time of molding, and then performing melt molding.

In a T-die method, a uniaxially stretched film obtained by rolling the melted resin extruded through the T-die while the resin is stretched in the rolling machine direction (lengthwise direction) or a biaxially stretched film is preferably used.

The setting conditions for the extruder during film formation of the uniaxially stretched film described above can be set appropriately in accordance with the structural unit composition of the liquid crystalline polyester, but the cylinder temperature setting is preferably within a range from 200 to 360° C., and more preferably within a range from 230 to 350° C. A temperature outside this range is not desirable, as thermal degradation of liquid crystalline polyester may occur, and film formation may sometimes become difficult.

The slit spacing of the T-die is preferably from 0.2 to 2 mm, and is more preferably from 0.2 to 1.2 mm. The range for the draft ratio of the above uniaxially stretched film is preferably from 1.1 to 40, more preferably from 10 to 40, and most preferably from 15 to 35.

This “draft ratio” refers to the value determined by dividing the cross-sectional area of the above T-die slit by the film cross-sectional area in the plane perpendicular to the lengthwise direction. If the draft ratio is less than 1.1, then the film strength may be insufficient, whereas if the draft ratio exceeds 45, then the surface smoothness of the film may sometimes be unsatisfactory. This draft ratio can be set by controlling the setting conditions for the extruder and the rolling rate.

The biaxially stretched film mentioned above is obtained by a method in which melt extrusion of the liquid crystalline polyester is performed under the same extruder setting conditions as those described above for film formation of the uniaxially stretched film, namely a cylinder temperature setting that is preferably within a range from 200 to 360° C.., and more preferably within a range from 230 to 350° C., and a T-die slit spacing that is preferably within a range from 0.2 to 1.2 mm, with the melted sheet that is extruded from the T-die being subjected to simultaneous stretching in both the lengthwise direction and the direction perpendicular to the lengthwise direction (the transverse direction). Further, the biaxially stretched film can also be obtained by a sequential stretching method in which the melted sheet extruded from the T-die is first stretched in the lengthwise direction, and this stretched sheet is then stretched in the transverse direction, within the same process, using a tenter under a high temperature of 100 to 300° C.

When producing the above biaxially stretched film, the stretch ratio is preferably from 1.2 to 40 times in the lengthwise direction, and from 1.2 to 20 times in the transverse direction. If the stretching ratios are outside the above ranges, then the film strength may be insufficient, and obtaining a film of uniform thickness may sometimes become difficult.

An inflation film or the like obtained by using an inflation method to perform film formation of the melted sheet extruded from a circular cylindrical die can also be used favorably. In other words, the liquid crystalline polyester is supplied to a melt kneading extruder equipped with an annular slit die, melt kneading is conducted at a cylinder temperature setting of 200 to 360° C., and preferably 230 to 350° C., and the melted resin is extruded upward or downward as a cylindrical film from the annular slit of the extruder. The spacing of the annular slit is typically from 0.1 to 5 mm, preferably from 0.2 to 2 mm, and more preferably from 0.6 to 1.5 mm. The diameter of the annular slit is typically from 20 to 1,000 mm, and preferably from 25 to 600 mm.

By applying a draft in the lengthwise direction (MD) to the melt extruded melted resin film described above, and blowing air or an inert gas such as nitrogen gas from the inside of the cylindrical film, the film can be expanded and stretched in the transverse direction (TD) perpendicular to the lengthwise direction.

In inflation molding (film formation), a preferred blow ratio (transverse direction stretching ratio: diameter of inflation bubble/diameter of annular slit) is from 1.5 to 10, and a ratio of 2 to 5 is more preferable. The draw down ratio (MD stretching magnification: bubble withdraw rate/resin discharge rate) is preferably from 1.5 to 50, and more preferably from 5 to 30. Furthermore, a so-called B-type (wine glass-shaped) bubble is preferably selected for the bubble shape. If the setting conditions during inflation film formation are outside the ranges described above, then obtaining a high-strength liquid crystalline polyester base material 2 of uniform width and with no wrinkles can sometimes become difficult.

The outer periphery of the expanded film is usually air-cooled or water-cooled, and the film is then pulled through nip rolls.

During inflation film formation, appropriate conditions for expanding the cylindrical melted film to a state having a uniform thickness and a smooth surface can be selected in accordance with the liquid crystalline polyester base material 2.

Although there are no particular limitations on the thickness of the liquid crystalline polyester base material 2 used in the present invention, the thickness is preferably from 3 to 1,000 μm, more preferably from 10 to 200 μm, and still more preferably from 12 to 150 μm. The liquid crystalline polyester obtained using the above method exhibits excellent heat resistance and electrical insulation, can be produced in a form that is lightweight and reduced in thickness, exhibits good mechanical strength, has flexibility, and is inexpensive.

Because the liquid crystalline polyester base material 2 obtained in this manner contains the liquid crystalline polyester having the predetermined structural unit composition described above, the base 2 material exhibits excellent water vapor barrier properties, and the water vapor permeation rate measured at a temperature of 40° C. and at a relative humidity of 90% is typically no more than 0.1 g/m²·24 h, preferably no more than 0.05 g/m²·24 h, more preferably no more than 0.01 g/m²·24 h, and still more preferably no more than 0.005 g/m²·24 h.

In the present invention, a surface treatment can be performed in advance on the surface of the liquid crystalline polyester base material 2. Examples of this type of surface treatment include a corona discharge treatment, plasma treatment, flame treatment, sputtering treatment, solvent treatment, ultraviolet treatment, polishing treatment, infrared treatment or ozone treatment.

The liquid crystalline polyester base material 2 may be colorless, or may incorporate a coloring component such as a pigment or a dye. Examples of the method of incorporating the coloring component include a method in which the coloring component is kneaded into the base material in advance during production of the film, and a method in which the coloring component is printed onto the liquid crystalline polyester base material 2. Further, a colored film and a colorless film may also be bonded together and used.

For the adhesive layer 3, a layer containing a general purpose adhesive such as an acrylic-based adhesive (mainly emulsion-type or solvent-type adhesives), a silicone-based adhesive (mainly solvent-type adhesives), or a rubber-based adhesive (mainly emulsion-type, solvent-type or hot melt-type adhesives) can be used. The adhesive layer 3 is typically formed by applying the adhesive to a hot melt adhesive layer. This application may be performed across the entire surface of the hot melt adhesive layer or a portion thereof. There are no particular limitations on the method used, and application can be performed using a known application method. Specifically, in the case where, for example, a solvent-type adhesive is applied, a method in which the adhesive is applied to a release paper using a knife coater or a reverse coater, and following drying, the release paper is humidified and then bonded to the above-mentioned hot melt adhesive layer is preferably used.

Because the label 1 has the type of structure described above, when this label 1 is used for performing process control of a product in a high-temperature treatment, the following procedure is used.

First, in advance, in a label sticking process, the liquid crystalline polyester base material 2 of the label 1 is stuck to a predetermined location on a product 6, as illustrated in FIG. 2A. In the label sticking process, a label sticking device (not shown in the drawings) is used, the protective film 5 of the label 1 is peeled from the adhesive layer 3 and removed, and the liquid crystalline polyester base material 2, including the adhesive layer 3, is pressed onto the predetermined location on the product 6. As a result, a state is obtained wherein the liquid crystalline polyester base material 2 is stuck to the product 6 via the adhesive layer 3.

Following sticking of the liquid crystalline polyester base material 2 of the label 1 to the predetermined location on the product 6 in the above process, the product is transported to a high-temperature treatment process. As illustrated in FIG. 2B, the product 6 is placed under a heat source 7, and by irradiating heat onto the product 6 from the heat source 7, a predetermined high-temperature treatment is performed, and process control of the product 6 is conducted.

At this time, the liquid crystalline polyester base material 2 of the label 1 is able to adequately satisfy the physical properties required of a film (such as operability and handling properties), particularly in the case where the flow beginning temperature of the liquid crystalline polyester is at least 280° C.

At this point, process control in the high-temperature treatment of the product 6 finishes.

### Embodiment 2 of the Present Invention

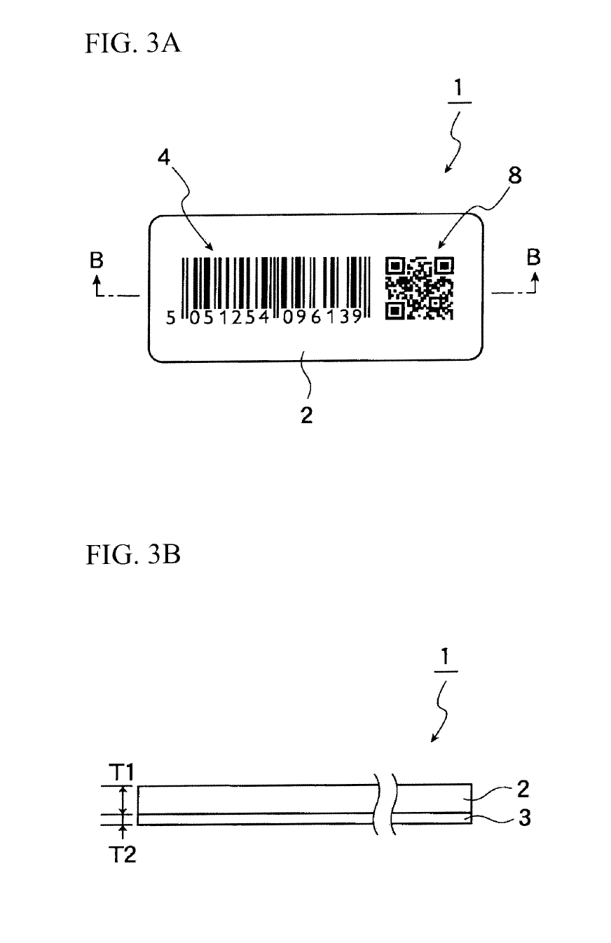

An embodiment 2 of the present invention is illustrated in FIG. 3A and FIG. 3B.

As illustrated in FIG. 3A, in a label 1 according to the embodiment 2 of the present invention, a matrix two-dimensional code 8 is printed, in addition to a barcode 4, onto the surface (the upper surface in FIG. 3B) of the liquid crystalline polyester base material 2, and the protective film 5 on the rear surface (the lower surface in FIG. 3B) of the adhesive layer 3 is omitted, and therefore with the exception of having a 2-layer structure composed of the liquid crystalline polyester base material 2 and the adhesive layer 3, the label 1 has the same structure as the embodiment 1 described above.

Accordingly, with this label 1, the same actions and effects as those described above for the embodiment 1 are achieved.

In addition, with this label 1, because not only the barcode 4, but also the two-dimensional code 8 is printed on the surface of the liquid crystalline polyester base material 2, this barcode and this two-dimensional code 8 can be used to incorporate a large amount of information. As a result, the label can also be used for complex process control of the product 6. Further, because this label 1 has a 2-layer structure composed of the liquid crystalline polyester base material 2 and the adhesive layer 3, the lack of necessity for the protective film 5 is able to reduce the material cost and production cost for the label 1.

### Other Embodiments of the Present Invention

In the embodiment 1 described above, a description was given of the label 1 having a 3-layer structure composed of the liquid crystalline polyester base material 2, the adhesive layer 3 and the protective film 5. Further, in the embodiment 2 described above, a description was given of the label 1 having a 2-layer structure composed of the liquid crystalline polyester base material 2 and the adhesive layer 3. However, depending on the properties of the product 6 to which the label 1 is stuck and other circumstances, a 1-layer structure composed of only the liquid crystalline polyester base material 2 can also be used.

Furthermore, in the embodiment 1 described above, a description was given of the label 1 in which the barcode 4 was printed on the surface of the liquid crystalline polyester base material 2. Further, in the embodiment 2 described above, a description was given of the label 1 in which the barcode 4 and the matrix two-dimensional code 8 were printed on the surface of the liquid crystalline polyester base material 2. However, the present invention can also be applied in a similar manner to a label 1 in which only the two-dimensional code 8 is printed on the surface of the liquid crystalline polyester base material 2. Further, a stacked two-dimensional code (not shown in the drawings) may be printed instead of the matrix two-dimensional code 8. Alternatively, the invention is not limited to a barcode 4 or two-dimensional code 8, and other symbols may also be used instead. Moreover, instead of printing these symbols onto the surface of the liquid crystalline polyester base material 2, a heat resistant resin layer (not shown in the drawings) formed of a polyimide or the like can be bonded to the surface of the liquid crystalline polyester base material 2, and the symbols then printed onto the surface of this heat resistant resin layer. These symbols need not necessarily be provided by printing, and methods other than printing (for example, bonding or laser printing or the like) may be used instead of, or in combination with, the printing method.

Moreover, in the embodiments 1 and 2 described above, descriptions were given of cases where the label 1 was stuck to a product 6, but the present invention can also be applied in a similar manner to the case where the label 1 is stuck to a packaging material (not shown in the drawings) for the product 6.

Furthermore, in the embodiments 1 and 2 described above, descriptions were given of cases where the label 1 was stuck for the purpose of process control of the product 6, but the present invention can also be applied in a similar manner to the case where the label 1 is stuck for the purpose of merchandise control for the product 6.

### EXAMPLES

Examples of the present invention are described below. However, the present invention is in no way limited by the examples.

### Synthesis Example 1

To a reactor equipped with a stirrer, a torque meter, a nitrogen gas inlet tube, a thermometer and a reflux condenser were added 1034.99 g (5.5 mols) of 2-hydroxy-6-naphthoic acid, 272.52 g (2.475 mols, an excess of 0.225 mols) of hydroquinone, 378.33 g (1.75 mols) of 2,6-naphthalenedicarboxylic acid, 83.07 g (0.5 mols) of terephthalic acid, 1,226.87 g (12 mols) of acetic anhydride, and 0.17 g of 1-methylimidazole as a catalyst, and following stirring for 15 minutes at room temperature, the temperature was increased while stirring was continued. When the internal temperature reached 145° C., the contents were stirred for 1 hour with the same temperature (145° C.) maintained.

Subsequently, the temperature of the contents was increased from 145° C. to 310° C. over a period of 3 hours and 30 minutes, while the by-product acetic acid and unreacted acetic anhydride were removed by distillation. The contents were than held at the same temperature (310° C.) for 3 hours to obtain a liquid crystalline polyester. The liquid crystalline polyester obtained in this manner was cooled to room temperature and ground in a grinder, yielding a powdered liquid crystalline polyester (prepolymer) having a particle size of approximately 0.1 to 1 mm. This is referred to as synthesis example 1.

In the liquid crystalline polyester of this synthesis example 1, the actual copolymer molar fraction, represented by the structural unit represented by the above formula (1): the structural unit represented by the above formula (2): the structural unit represented by the above formula (3), is 55 mol %: 22.5 mol %: 22.5 mol %. Further, in the liquid crystalline polyester of this synthesis example 1, the copolymer molar fraction of structural units containing a 2,6 naphthalenediyl group is 72.5 mol % based on the total amount of all these structural units.

A powder obtained in the same manner as synthesis example 1 was heated from 25° C. to 250° C. over a period of 1 hour, was subsequently heated from the same temperature (250° C.) to 293° C. over a period of 5 hours, and was then held at the same temperature (293° C.) for 5 hours to effect a solid phase polymerization. Subsequently, the powder following the solid phase polymerization was cooled to obtain a powdered liquid crystalline polyester. This is referred to as synthesis example 2.

In the liquid crystalline polyester of this synthesis example 2, the actual copolymer molar fraction, represented by the structural unit represented by the above formula (1): the structural unit represented by the above formula (2): the structural unit represented by the above formula (3), is 55 mol% : 22.5 mol %: 22.5 mol %. Further, in the liquid crystalline polyester of this synthesis example 2, the copolymer molar fraction of structural units containing a 2,6 naphthalenediyl group is 72.5 mol % based on the total amount of all these structural units.

A powder obtained in the same manner as synthesis example 1 was heated from 25° C. to 250° C. over a period of 1 hour, was subsequently heated from the same temperature (250° C.) to 310° C. over a period of 10 hours, and was then held at the same temperature (310° C.) for 5 hours to effect a solid phase polymerization. Subsequently, the powder following the solid phase polymerization was cooled to obtain a powdered liquid crystalline polyester. This is referred to as synthesis example 3.

In the liquid crystalline polyester of this synthesis example 3, the actual copolymer molar fraction, represented by the structural unit represented by the above formula (1): the structural unit represented by the above formula (2): the structural unit represented by the above formula (3), is 55 mol %: 22.5 mol %: 22.5 mol %. Further, in the liquid crystalline polyester of this synthesis example 3, the copolymer molar fraction of structural units containing a 2,6 naphthalenediyl group is 72.5 mol % based on the total amount of all these structural units.

### Synthesis Example 4

To a similar reactor to that used in synthesis example 1 were added 911 g (6.6 mols) of p-hydroxybenzoic acid, 409 g (2.2 mols) of 4,4′-dihydroxybiphenyl, 91 g (0.55 mols) of isophthalic acid, 274 g (1.65 g) of terephthalic acid and 1,235 g (12.1 mols) of acetic anhydride, and the mixture was stirred. Subsequently, 0.17 g of 1-methylimidazole was added to the contents, and following thorough replacement of the air inside the reactor with nitrogen gas, the temperature was increased to 150° C. under a stream of nitrogen gas over a period of 15 minutes, and this temperature was then held while the contents were refluxed for 1 hour. Subsequently, 1.7 g of 1-methylimidazole was added, and the temperature of the contents was increased to 320° C. over a period of 2 hours and 50 minutes, while the by-product acetic acid and unreacted acetic anhydride were removed by distillation. Subsequently, the point where an increase in torque was noticed was deemed the end of the reaction, and the contents were removed from the reactor. The liquid crystalline polyester obtained in this manner was cooled to room temperature and ground in a grinder, yielding a powder of a liquid crystalline polyester (prepolymer) having a particle size of approximately 0.1 to 1 mm.

The powder obtained in this manner was heated from 25° C. to 250° C. over a period of 1 hour, was subsequently heated from the same temperature (250° C.) to 285° C. over a period of 5 hours, and was then held at the same temperature (285° C.) for 3 hours to effect a solid phase polymerization. Subsequently, the powder following the solid phase polymerization was cooled to obtain a powdered liquid crystalline polyester. This is referred to as synthesis example 4.

### <Measurement of Flow Beginning Temperature>

For each of the synthesis examples 1 to 4, the flow beginning temperature of the powdered liquid crystalline polyester was measured. In other words, using a flow tester (model: CFT-500, manufactured by Shimadzu Corporation), a sample of approximately 2 g was packed in a capillary rheometer equipped with a die having an internal diameter of 1 mm and a length of 10 mm. The temperature at which the melt viscosity reached 4,800 Pa·s (48,000 poise) when the liquid crystalline polyester was extruded from the nozzle under a loading of 9.8 MPa (100 kgf/cm²) and at a rate of temperature increase of 4° C/minute was recorded as the flow beginning temperature. These results are shown in Table 1.

Further, for each of the synthesis examples 1 to 4, the powdered liquid crystalline polyester was granulated to produce pellets, and the flow beginning temperature of this pelletized liquid crystalline polyester was measured. In other words, using 500 g of each of the liquid crystalline polyester powders from synthesis examples 1 to 4, each of the powders was granulated using a twin screw extruder (PCM-30, manufactured by Ikegai Corporation) at a temperature within a range from the flow beginning temperature of the liquid crystalline polyester powder to a temperature 10° C. higher than the flow beginning temperature, thus obtaining pellets. The flow beginning temperatures of the pellets corresponding with synthesis examples 1 to 4 obtained in this manner were measured. These results are shown in Table 1.

### <Measurement of Melt Tension>

In order to prepare the liquid crystalline polyester base material industrially in a stable manner, a certain level of melt tension is required, and therefore the melt tension of the pelletized liquid crystalline polyester was measured for each of the synthesis examples 1 to 4. At this time, for each of the pellets, the melt tension measurement was conducted at a temperature higher than the flow beginning temperature of the pellets, and a maximum value was determined for the melt tension. Further, the temperature at which the sample could not be pulled out into a thread-like form, meaning the melt tension measurement could not be performed, was also determined.

In other words, using a melt viscosity measurement tester (model: capillograph 1B, manufactured by Toyo Seiki Seisaku-sho, Ltd.), approximately 10 g of the sample was placed in the tester, the sample was pulled out into a thread-like form using a cylinder barrel diameter of 1 mm and a piston extrusion rate of 5 mm/minute, while the rate was automatically increased using a variable speed winder, and the tensile force when the sample fractured was recorded as the melt tension (units: N). These results are shown in Table 1.

TABLE 1

| | Synthesis | Synthesis | Synthesis | Synthesis |
|---|---|---|---|---|
| | Example 1 | Example 2 | Example 3 | Example 4 |
| Flow beginning | 267 | 317 | 333 | 327 |
| temperature | | | | |
| of liquid | | | | |
| crystalline | | | | |
| polyester (° C.) | | | | |
| Granulation | 275 | 325 | 340 | 335 |
| temperature | | | | |
| (° C.) | | | | |
| Pellet flow | 267 | 300 | 308 | 318 |
| beginning | | | | |
| temperature | | | | |
| (° C.) | | | | |
| Melt tension | 0.98 | 25 | 93 | 14 |
| maximum value | | | | |
| (10⁻³ N) | | | | |
| Measured | Measurement | 125 | 93 | 14 |
| value for melt | impossible | [310° C.] | [330° C.] | [350° C.] |
| tension at each | | | | |
| measurement | | | | |
| temperature | | | | |
| (10⁻³ N) | | | | |
| Value in | | 19 | 60 | 7.8 |
| brackets [ ] | | [320° C.] | [340° C.] | [360° C.] |
| represents the | | 12 | 43 | |
| measurement | | [330° C.] | [350° C.] | |
| temperature | | 6.9 | 33 | |
| | | [350° C.] | [360° C.] | |
| Temperature | — | 305 | 325 | 355 |
| at which | | | | |
| measurement | | | | |
| of melt tension | | | | |
| becomes | | | | |
| impossible | | | | |
| (° C.) | | | | |

For the liquid crystalline polyester of synthesis example 1, when the melt tension measurement was performed at a measurement temperature of no more than 300° C., the sample could not be pulled into a thread-like form, whereas when the measurement temperature was 310° C. or higher, the resin flowed without adopting a thread-like form, meaning measurement of the melt tension was impossible. Melt tension measurements were attempted at a measurement temperature between 300 and 310° C., but although the sample was sometimes able to be pulled into a thread-like form, the melt tension was too low and the thread fractured, and therefore the melt tension could not be calculated.

### Example 1

Using the liquid crystalline polyester obtained in synthesis example 3, a liquid crystalline polyester base material having a thickness of 25 μm was prepared. Namely, the powder of this liquid crystalline polyester was melted inside a single screw extruder (screw diameter: 50 mm), and the melt was extruded as a film from a T-die at the tip of the single screw extruder (lip length: 300 mm, lip clearance: 1 mm, die temperature: 350° C.) and then cooled, completing preparation of a liquid crystalline polyester base material (example 1) having a thickness of 25 μm.

### Example 2

Using the liquid crystalline polyester obtained in synthesis example 3, a liquid crystalline polyester base material having a thickness of 50 μm was prepared. Namely, the powder of this liquid crystalline polyester was melted inside a single screw extruder (screw diameter: 50 mm), and the melt was extruded as a film from a T-die at the tip of the single screw extruder (lip length: 300 mm, lip clearance: 1 mm, die temperature: 350° C.) and then cooled, completing preparation of a liquid crystalline polyester base material (example 2) having a thickness of 50 μm.

### Comparative Example 1

Using the liquid crystalline polyester obtained in synthesis example 4, the same procedure as that described for example 1 was used to prepare a liquid crystalline polyester base material (comparative example 1) having a thickness of 25 μm.

### <Light Resistance Test>

For example 1 and comparative example 1, the strength retention rate upon light irradiation was determined in order to evaluate the light resistance of the liquid crystalline polyester base material. In other words, using an accelerated weather resistance tester (High-Energy Xenon Weather Meter SC700-WN, manufactured by Suga Test Instruments Co., Ltd.), light irradiation was performed under the following conditions.

Wavelength: continuous light of at least 275 nm (short wavelength side cut by filter)

Intensity: 160 W/cm² (lamp output)

Temperature: 65° C. (measured by flat panel thermometer at same location as irradiated surface)

Time: 60 hours

The strength of the liquid crystalline polyester base material following the light irradiation was divided by the strength of the liquid crystalline polyester base material prior to the light irradiation to calculate the strength retention rate.

The results revealed that whereas the strength retention rate was 7% in comparative example 1, it was 75% in example 1 (namely, approximately 11 times that of comparative example 1). Based on these results, it was evident that compared with comparative example 1, the light resistance of the liquid crystalline polyester base material of example 1 was an order of magnitude more superior.

### <Evaluation of Water Vapor Barrier Properties>

For example 1, example 2 and comparative example 1, the water vapor permeation rate was determined in order to evaluate the water vapor barrier properties of the liquid crystalline polyester base material. In other words, using a gas permeation rate-water vapor permeability measurement device (GTR-30X, manufactured by GTR Tec Corporation), the water vapor permeation rate of the liquid crystalline polyester base material under conditions including a temperature of 40° C. and a relative humidity of 90% was measured in accordance with the method of JIS K7129 C.

The results revealed that whereas the water vapor permeation rate was 0.343 g/m²·24 h in comparative example 1, it was 0.011 g/m²·24 h in example 1 (namely, approximately 1/31 that of comparative example 1). Based on these results, it was evident that compared with comparative example 1, the water vapor barrier properties of the liquid crystalline polyester base material of example 1 were extremely high. Furthermore, the result for example 2 was 0.0030 g/m²·24 h, which confirmed that the water vapor barrier properties of the liquid crystalline polyester base material were extremely high.

### INDUSTRIAL APPLICABILITY

The label of the present invention can be widely applied in industries that require labels having a heat resistance similar to the product or the packaging materials thereof, including industries such as machinery, electrical and electronic componentry and foodstuffs.

### DESCRIPTION OF THE REFERENCE SIGNS

1: Label
2: Liquid crystalline polyester base material
3: Adhesive layer
4: Barcode (symbol)
5: Protective film
6: Product
7: Heat source
8: Two-dimensional code (symbol)
T1: Thickness of liquid crystalline polyester base material
T2: Thickness of adhesive layer
T3: Thickness of protective film

1. A heat-resistant label comprising a liquid crystalline polyester base material, wherein a liquid crystalline polyester in the liquid crystalline polyester base material comprises
a structural unit represented by the following formula (1);
a structural unit represented by the following formula (2); and
a structural unit represented by the following formula (3); and
wherein an amount of structural units containing a 2,6 naphthalenediyl group is at least 40 mol % based on the total amount of all structural units:
(1) —O—Ar¹—CO—
(2) —O—Ar²—CO— and
(3) —O—Ar³—O—
(wherein, Ar¹ represents a 2,6-naphthalenediyl group, a 1,4-phenylene group, or a 4,4′-biphenylylene; each of Ar² and Ar³ independently represents a 2,6-naphthalenediyl group, a 1,4-phenylene group, a 1-3-phenylene group, or a 4,4′-biphenylylene group; and hydrogen atoms which are in the group represented by Ar¹, Ar² or Ar³ may be each independently substituted with a halogen atom, an alkyl group having 1 to 10 carbon atoms, or an aryl group having 6 to 20 atoms).

2. The label according to claim 1,
wherein the liquid crystalline polyester has a flow beginning temperature that is at least 280° C.

3. The label according to claim 1,
wherein the liquid crystalline polyester base material has a water vapor permeation rate that is no more than 0.1 g/m^{2·24} h as measured at a temperature of 40° C. and at a relative humidity of 90%.

4. A label comprising a liquid crystalline polyester based material,
wherein the liquid crystalline polyester base material has a water vapor permeation rate that is no more than 0.005 g/m²·24 h as measured at a temperature of 40° C. and at a relative humidity of 90%.

5. A label comprising a liquid crystalline polyester based material,
wherein a liquid crystalline polyester in the liquid crystalline polyester base material has a vapor permeation rate that is no more than 0.005 g/m²·24 h as measured at a film thickness of 50 μm, at a temperature of 40° C., and at a relative humidity of 90%.

6. The label according to claim 1,
wherein the liquid crystalline polyester base material comprises at least one member selected from the group consisting of an ultraviolet absorption agent and an ultraviolet scattering agent.

7. The label according to claim 4,
wherein the liquid crystalline polyester base material comprises at least one member selected from the group consisting of an ultraviolet absorption agent and an ultraviolet scattering agent.

8. The label according to claim 5,
wherein the liquid crystalline polyester base material comprises at least one member selected from the group consisting of an ultraviolet absorption agent and an ultraviolet scattering agent.

9. The label according to claim 1,
wherein an adhesive layer is laminated on a rear surface of the liquid crystalline polyester base material.

10. The label according to claim 4,
wherein an adhesive layer is laminated on a rear surface of the liquid crystalline polyester base material.

11. The label according to claim 5,
wherein an adhesive layer is laminated on a rear surface of the liquid crystalline polyester base material.

12. The label according to claim 9,
wherein a protective film is releasably laminated on a rear surface of the adhesive layer.

13. The label according to claim 10,
wherein a protective film is releasably laminated on a rear surface of the adhesive layer.

14. The label according to claim 11,
wherein a protective film is releasably laminated on the rear surface of the adhesive layer.

15. The label according to claim 1,
wherein a symbol is provided on a surface of the liquid crystalline polyester base material.
